(19) United States
(12) Patent Application Publication
(10) Pub. No.: US 2005/0269142 A1
(43) Pub. Date: Dec. 8, 2005

(54) Pallet truck

(76) Inventors: Jan Herschel, Bad Oldesloe (DE); Klaus-Peter Ribbentrop, Henstedt-Ulzburg/Rhen (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/858,808

(22) Filed: Jun. 2, 2004

(51) Int. Cl. B60K 1/00

(52) U.S. Cl. 180/65.1

(57) ABSTRACT

A pallet truck, having a longitudinal and a transverse axis, the pallet truck comprising a load bearing part and a driving part which parts being arranged one after the other on the longitudinal axis, a driver platform in the driver part which is designed such that the viewing direction of the driver if standing in normal operating position on the platform extends transverse to the longitudinal axis, the driver platform having an open entering side and an armrest on the opposite side, the front end of the armrest being provided with control elements for controlling individual functions of the pallet truck, the armrest can be lifted or lowered together with the control elements.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention refers to a pallet truck, in particular to a reach truck. In these trucks the mast which guides the loading fork or the bearing means for the loading fork can be moved towards to or away from a drive part of the truck. The driver sits or stands on a platform such that the viewing direction is transverse to the longitudinal axis of the truck. The sitting or standing direction is such that the right shoulder of the driver faces the mast or the bearing means, respectively. The boarding side is on the opposite side of the driving part. The right arm of the driver rests on an armrest adjacent to the platform or the driver seat, respectively and in front of the armrest control elements are positioned, e.g. in the form of a joystick, a multi-pilot or a lever or the like.

In known pallet trucks the mentioned armrest together with the control elements are located in predetermined height. Since the drivers have different statures the armrest and the control elements in many cases are too high or too low and thus are uncomfortable for the driver.

Therefore, it is an object of the invention to provide a pallet truck, in particular a reach truck, wherein optimum ergonomic conditions are achieved for drivers of different statures.

### BRIEF SUMMARY OF THE INVENTION

In a pallet truck according to the invention the armrest in conjunction with the control elements is height-adjustable. Each driver can in correspondence with his stature adjust the armrest according to his requirements in order to work ergonomically satisfactorily.

Different possibilities are conceivable to adjust the armrest. According to an embodiment of the invention, the driver platform has an upright guide profile. The profile for example can be a post rectangular in cross-section. The armrest at the end opposite to the control elements includes a guiding portion which cooperates with the upright guide profile such that the armrest or the guide portion may be continuously or by steps moved up and down. Finally, locking means are provided to fix the guiding portion at a predetermined height at the guiding profile.

In order to lock the armrest on the guiding profile a clamping mechanism can be provided to clamp the guiding portion at a desired height at the guiding profile. To this purpose the guiding portion may have two clamping jaws interlinked at one end and embrace the guiding profile. A clamping threaded fastener at the other end of the clamping jaws is to exert a pressure on the clamping jaws in order to clamp the jaws to the guiding profile.

To facilitate the tightening or releasing of the clamping means an embodiment of the invention provides a hand-wheel as the head of the clamping threaded fastener.

Another embodiment of the invention proposes a thrust spring between the guiding portion and a lower stop in order to bias the guiding portion upwardly towards an abutment on the guiding profile. The thrust spring may be a coil spring which surrounds the guiding profile.

### BRIEF DESCRIPTION OF THE SEVERAL VIEWS OF THE DRAWINGS

An embodiment example is subsequently described along accompanying drawings wherein:

FIG. 1 shows diagrammatically a lateral view on a pallet truck according to the invention with a relatively small driver.

FIG. 2 shows the pallet truck of FIG. 1 with a relatively tall driver.

FIG. 3 shows diagrammatically and with an enlarged scale the lateral view of the armrest of the pallet truck of FIGS. 1 and 2.

FIG. 4 shows a cross-section through the illustration of FIG. 3 along line 4-4 and

FIG. 5 shows a cross-section through the illustration of FIG. 4 along line 5-5.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

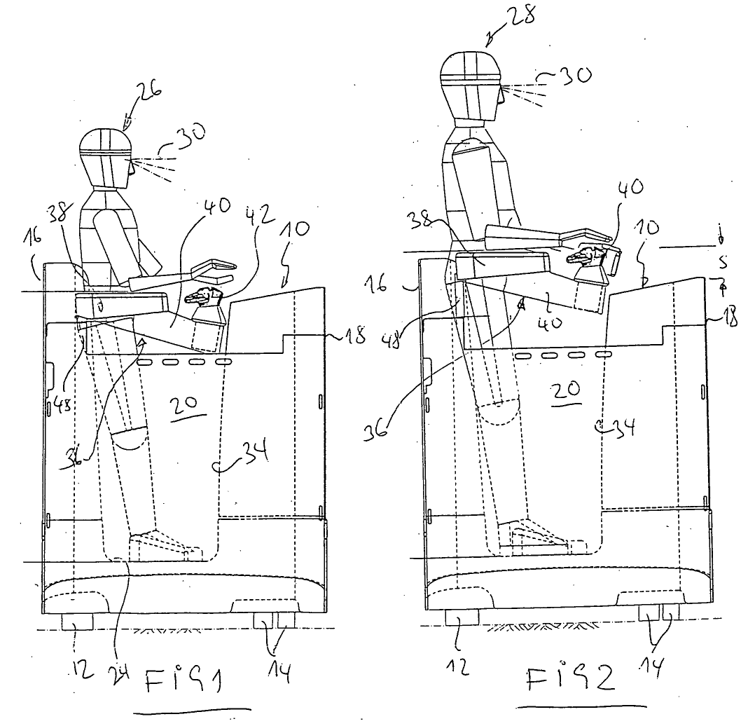

In FIGS. 1 and 2 a chassis or a frame of a pallet truck not shown in detail is shown at 10. The pallet truck may be a reach truck. The chassis accomodates a driving motor and steering means for a wheel 12 driven by the driving motor. Driving motor and steering means are not shown. A pair of support wheels 14 are adjacent to driving wheel 12. A mast which is connected to the driving part, is above the drawing plane and thus cannot be seen. The mast is fixedly attached to chassis 10 and may be moved towards to and away from the driving part and guides a loading fork for the receipt of a load.

The chassis of the driving part has opposing side walls 16, 18 and a third side wall 20 which faces the mast.

The side walls 16, 18, 20 border a platform 24 (depicted by dashed lines). The driver who is indicated in FIGS. 1 and 2 at 26 and 28 stands on the platform 24 and his back is facing wall 16. The driver may rest against a backrest not shown or at a so-called stand-seat. His viewing direction 30 is transverse to the longitudinal axis of the pallet truck which axis as can be seen in the description above is perpendicular to the drawing plane. The entry of the platform is through an entering opening 34 which is opposite to side wall 20.

On the right side of the driver 26, 28 above the wall an arm 36 is attached which includes an armrest 38 and an arm portion 40 in extension of the armrest which extends obliquely downwardly. At the front end of the arm portion 40 a multi-pilot 42 is located. The multi-pilot includes a plurality of control elements for controlling individual functions of the reach truck not shown in detail. The portions described above belong to prior art.

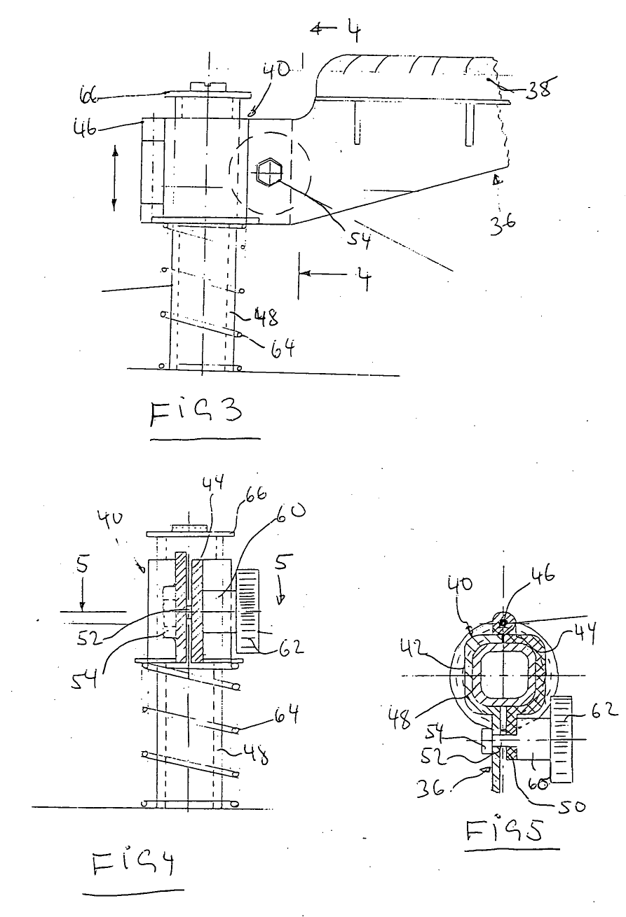

In FIGS. 3 to 5 arm 36 and the mounting means for the arm 36 on the platform are shown in more detail.

It can be seen in FIGS. 3 to 5 that arm 36 together with armrest 38 are connected to a guiding portion 40 which is easily recognizable in FIGS. 4 and 5. The guiding portion 40 has two clamping jaws 42, 44 U-shaped in cross-section and which at one end are linked to each other through a pin 46. The clamping jaws 42, 44 surround a tube 48 square in cross-section. The clamping jaw 42 is integral with arm 36 while the other clamping jaw 44 has a flange 50 extending parallel to arm 36. A screw-bolt 52 extends through flange 50 which is threaded into a nut 54 which is fixedly attached to arm 36, e.g. by welding. Flange 50 has a hole through which the bolt 52 is extended. A truss 60 is connected to bolt 52, and a hand-wheel 62 is connected to truss 60. When bolt 52 is threaded into nut 54 the associated end of truss 60 engages flange 50 and presses flange 50 against arm 36. Thereby the guiding portion 40 is fixedly clamped to tube 48. If by actuation of hand-wheel 62 bolt 52 is released the guiding portion 40 may be moved up and down to a predetermined height.

In FIGS. 3 and 4 the upright tube-like guiding profile can be seen. It is indicated at 48 in FIG. 1 or 2. The attachment of the guiding profile 48 on the platform according to FIGS. 1 and 2 is not shown in detail. The guiding profile can be threaded or welded to the platform.

The guiding profile 48 is surrounded by a thrust spring 64 which with the lower end engages an abutment not shown in detail. At the upper end the thrust spring 64 acts on the guiding portion 40 and biases it towards abutment 66 which is attached to the upper end of the guiding profile 48. The thrust spring 64 avoids a sudden downward movement of the armrest after release of hand-wheel 62.

If the hand-wheel 62 is released, the guiding portion 40 and thus arm 36 can be urged downwardly or will be moved upwardly by spring 64 towards abutment 66. When the desired height is reached, the hand-wheel 62 can be again tightened so that the armrest 36 and the multi-pilot with the control elements have an optimum position adapted to the stature of the driver. This can be clearly seen in FIG. 1. In FIG. 2 the displacement travel of the guiding portion is indicated with S. It indicates the displacement between FIG. 1 and FIG. 2. In FIG. 1 the driver 26 has a small stature while in FIG. 2 driver 28 has a larger stature. For both an ergonomically optimum adjustment of the armrest 38 and the multi-pilot 40 is achieved and the elbow and the lower arm can be comfortably supported by the armrest 38 so that the multi-pilot 40 can be actuated without fatigue. In both cases the lower arm of the driver 26, 28 extends approximately horizontally.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A pallet truck, having a longitudinal and a transverse axis, the pallet truck comprising a load bearing part and a driving part which parts being arranged one after the other on the longitudinal axis, a driver platform in the driver part which is designed such that the viewing direction of the driver if standing in normal operating position on the platform extends transverse to the longitudinal axis, the driver platform having an open entering side and an armrest on the opposite side, the front end of the armrest being provided with control elements for controlling individual functions of the pallet truck, the armrest can be lifted or lowered together with the control elements.

2. The pallet truck of claim 1, wherein the driver platform has an upright guiding profile, the armrest on the end opposite to the control elements has a guiding portion which cooperates with the guiding profile to be displaced along the guiding profile continuously or by steps and locking means are provided to lock the guiding portion at different elevated positions at the guiding profile.

3. The pallet truck of claim 2, wherein the guiding portion has two interlinked clamping jaws which surround the guiding profile, with the other end of the clamping jaws can be pressed against each other by a clamping bolt.

4. The pallet truck of claim 3, wherein the head of the clamping bolt is designed as a hand-wheel.

5. The pallet truck of claim 2, wherein the guiding portion is biased upwardly towards abutment means of the guiding profile.
